(19) United States
(12) Patent Application Publication
(10) Pub. No.: US 2007/0078969 A1
(43) Pub. Date: Apr. 5, 2007

(54) Composite communication service management

(76) Inventors: Chuong Ngoc Ngo, Ottawa (CA); Attaullah Zabihi, Kanata (CA); Tibor Fasanga, Stittsville (CA); Ralph Harry Quapp, Ottawa (CA)

Correspondence Address: ECKERT SEAMANS CHERIN & MELLOTT, LLC., US STEEL TOWER, 600 GRANT STREET, 44TH FLOOR, PITTSBURGH, PA, 15219-2788, US

(21) Appl. No.: 11/243,005

(22) Filed: Oct. 4, 2005

(51) Int. Cl. G06F 15/173

(52) U.S. Cl. 709/224

(57) ABSTRACT

Systems and techniques for managing a group of communication services as a single composite communication service are disclosed. When a composite communication service, to be provided by one or more communication services which are supported in a communication system, has been defined, a representation of that composite communication service can be provided. This representation may be in the form of a visual representation displayed on a display or a representation stored in a memory, for example. The composite communication service may be defined manually by a user or automatically detected by a management system on the basis of configuration information associated with the actual configuration of communication equipment in the communication system. Related data structures and user interfaces are also disclosed.

### CROSS-REFERENCE TO RELATED APPLICATIONS

This application is related to U.S. patent applications Ser. No. ______ <Attorney Docket No.: 51236-86>, entitled “COMMUNICATION SYSTEM HIERARCHICAL TESTING SYSTEMS AND METHODS—ENTITY DEPENDENT AUTOMATIC SELECTION OF TESTS”, and Ser. No. ______ <Attorney Docket No.: 51236-87>, entitled “MANAGEMENT OF TIERED COMMUNICATION SERVICES IN A COMPOSITE COMMUNICATION SERVICE”, both filed of even date herewith and assigned to the Assignee of the present application. The entire contents of each of these related applications are incorporated herein by reference.

### FIELD OF THE INVENTION

This invention relates generally to communications and, in particular, to composite communication services provided by one or more component communication services supported in a communication system.

### BACKGROUND

Current communication network and service management systems only handle individual services, such as VLAN (Virtual Local Area Network), VPLS (Virtual Private LAN Service), MPLS/BGP VPN (Multi-Protocol Label Switching/Border Gateway Protocol Virtual Private Network), also sometimes referred to Layer 3 VPN or VPRN (Virtual Private Routed Network), PW (pseudo-wire), and so on. Although these current management solutions may be suitable for simple VPNs using a single technology, complex applications to provide so-called “triple play” services, for instance, typically involve service providers having their services span over multiple management domains and/or technologies.

In addition, current network management systems tend to be aware of only some of the connectivity between communication services. A management system for a communication network, for example, might be aware of connectivity between individual service sites which support a communication service, but does not take into account the connectivity from all sites of a given service to others as a whole. Some of the service interconnections are also not detectable in current networks.

Thus, there remains a need for improved techniques for managing composite communication services in a communication system.

### SUMMARY OF THE INVENTION

Some embodiments of the invention are directed to the problem of efficiently managing multiple communication services in a communication system, including VPLS, MPLS/BGP VPN, VLAN, and pseudo-wire, among others, when they are used in combination to provide a subscriber service such as a triple play service. Techniques to connect communication services together, different hierarchical views of grouped/connected communication services which have been configured to provide a composite communication service, and aggregation of alarms from individual services are proposed herein and in the related applications referenced above.

Discovery of service connectors and automatic updating and/or creation of composite communication services are also proposed. Logical associations between individual service components may be determined via discovery of service connectors. New composite communication services can be created, component communication services may be added to existing composite communication services, and violation of connectivity rules may all be detected based on discovery of service connectors.

According to an embodiment of the invention, there is provided a system including a composite communication service detector and a composite communication service manager. The composite communication service detector is adapted to detect that a composite communication service, to be provided by one or more communication services supported in a communication system, has been defined. The composite communication service manager is operatively coupled to the detector and adapted to provide a representation of the composite communication service. The representation includes an indication of whether a communication service is configured to provide the composite communication service.

The system may also include an interface adapted to receive inputs, and a composite communication service configuration module operatively coupled to the interface. The composite communication service configuration module is adapted to receive through the interface inputs for defining a composite communication service. The composite communication service configuration module may be further adapted to receive inputs for configuring a communication service to provide the composite communication service.

In some embodiments, the interface is further adapted to allow access to the representation for performing management functions on the composite communication service. The management functions may include one or more of: configuring a communication service supported by the communication system to provide the composite communication service, removing a communication service from the composite communication service, and deleting the composite communication service.

The manager may be further adapted to enforce a set of composite communication service rules. The set of rules may include one or more of: a rule that a communication service may be configured to provide only one composite communication service, and a rule that a communication service may be removed from a composite communication service only if the communication service is not configured for operation with any other communication service which provides the composite communication service.

In another embodiment, the system includes an interface operatively coupled to the detector for receiving configuration information associated with a communication service supported in the communication system. In this case, the detector is adapted to detect that a composite communication service has been defined by determining, based on the configuration information, whether the communication service is configured for operation with another communication service supported in the communication system to provide a composite communication service.

The system may also include a display and/or a memory. The manager may then provide a representation by displaying on the display a visual representation of the composite communication service, and/or storing in the memory a representation of the composite communication service.

The detector may also be adapted to-determine whether a communication service supported in the communication system is configured to provide the composite communication service by detecting service connectors between communication services. Each service connector specifies a logical association between communication services.

Service connectors may include one or more of a service connector specifying a logical association between service interfaces through which communication services are accessible, a service connector specifying a pseudo-wire connection between communication equipment on which communication services are supported, and a service connector specifying a connection, between services supported on common communication equipment, through a configurable connection device implemented in the communication equipment.

In some embodiments, the manager is adapted to determine whether communication services are configured to provide a previously defined composite communication service, to create a new composite communication service where the communication services are not configured to provide a previously defined composite communication service, and to update the previously defined composite communication service where the communication services are configured to provide the previously defined composite communication service.

The manager may determine whether the communication services are configured to provide a previously defined composite communication service by determining whether one or more of the communication services are also configured to provide a previously defined composite communication service, and update the previously defined composite communication service to include the communication services where only one of the communication services is also configured to provide a previously defined composite communication service.

Where more than one of the communication services are also configured to provide respective different previously defined composite communication services, the manager may perform one or more of the following operations: raise an alarm for one or more of the communication services, the respective different composite communication services, and a service connector specifying a logical association between the communication services, select one of the respective different previously defined composite communication services and update the respective different previously defined communication services so that each of the communication services is included in only the selected previously defined composite communication service, create a new composite communication service including the communication services, and create a new composite communication service including the communication services and any other communication services with which one or more of the communication services have been configured for operation.

A method according to another aspect of the invention includes detecting that a composite communication service, to be provided by one or more communication services supported in a communication system, has been defined, and providing a representation of the composite communication service. The representation includes an indication of whether a communication service is configured to provide the composite communication service.

The operation of detecting may involve detecting that a composite communication function has been defined based on one or more of inputs received from a user and configuration information associated with a communication service supported in the communication system.

The method may also include at least one of: detecting that a composite communication service has been modified, wherein providing further comprises providing a representation of the modified composite communication service, and detecting that a composite communication service has been deleted, wherein the representation of a deleted composite communication service is removed.

These operations may be performed in any of various ways, and the method may also include further operations, some of which have been briefly described above.

Another aspect of the invention provides a machine-readable medium storing a data structure which includes information identifying a composite communication service to be provided by one or more communication services supported in a communication system, and information indicating whether a communication service supported in the communication system has a relationship with the composite communication service.

The information indicating whether a communication service supported in the communication system has a relationship with the composite communication service may include information identifying multiple communication services. In this case, the data structure may also include information defining a logical connection between the communication services.

In some embodiments, the composite communication service includes multiple hierarchical levels, the information indicating whether a communication service supported in the communication system has a relationship with the composite communication service includes information identifying a communication service, and the data structure further includes information indicating a hierarchical level of the communication service in the composite communication service.

The data structure may include multiple data records, including data records having any of these data structures.

Yet another aspect of the invention provides a user interface which includes a visual element representing a composite communication service to be provided by one or more communication services supported in a communication system, a visual element representing communication services configured to provide the composite communication service, and respective visual elements representing a logical association, if any, between communication services configured to provide the composite communication service.

Other aspects and features of the present invention will become apparent to those ordinarily skilled in the art upon review of the following description of specific illustrative embodiments thereof.

### BRIEF DESCRIPTION OF THE DRAWINGS

Examples of embodiments of the invention will now be described in greater detail with reference to the accompanying drawings, in which:

FIG. 1 is a block diagram of a communication system;

FIG. 2 is a block diagram illustrating component communication services involved in providing a composite communication service;

FIG. 3 is a block diagram of a composite communication service management system;

FIG. 4 is a flow diagram of a composite communication service management method;

FIG. 5 is a block diagram of a UI (User Interface) for defining and managing a composite communication service;

FIG. 6 is a block diagram of a component communication service UI;

FIG. 7 is a block diagram of a service connector UI;

FIG. 8 is a block diagram of a UI displaying a representation of a composite communication service and communication services configured to provide the composite communication service;

FIG. 9 is a block diagram of a data structure representing a composite communication service;

FIG. 10 is a block diagram of a data structure representing a service connector; and

FIG. 11 is a block diagram of a data structure representing a communication service.

### DETAILED DESCRIPTION OF PREFERRED EMBODIMENTS

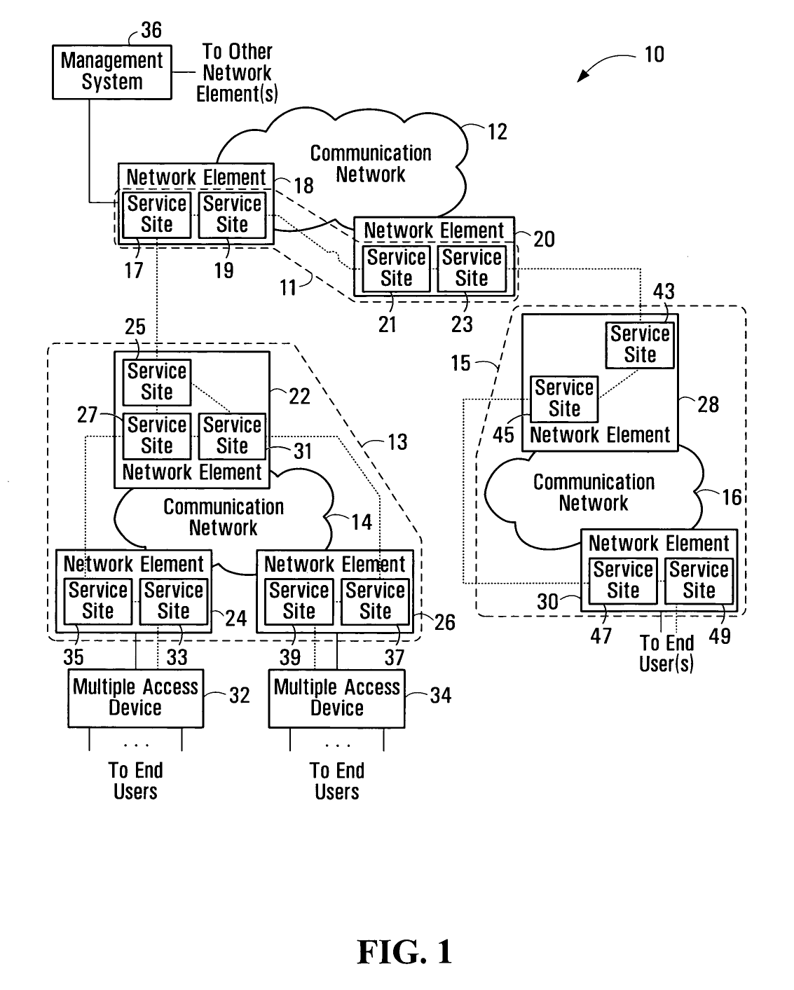

FIG. 1 is a block diagram of a communication system. The communication system 10 includes multiple communication networks 12, 14, 16 having network elements 18, 20, 22, 24, 26, 28, 30. The network elements 24, 26 of the communication network 14 are operatively coupled to multiple access devices 32, 34 which provide access to the communication network 14 for end users. Any or all of the network elements 18, 20, 22, 24, 26, 28, 30 may be managed by a management system 36.

Communication systems may have many different topologies, including more or fewer communication networks having similar or different equipment than shown in FIG. 1. For example, different communication networks may use different access schemes. As shown, end users access the communication network 14 through multiple access devices 32, 34, whereas more direct end user access is provided to the communication network 16 through the network element 30. It should therefore be appreciated that the system of FIG. 1, as well as the contents of the other drawings, are intended solely for illustrative purposes, and that the present invention is in no way limited to the particular example embodiments explicitly shown in the drawings and described herein.

Switches and routers are illustrative of the types of communication equipment represented by the network elements 18, 20, 22, 24, 26, 28, 30. The communication networks 12, 14, 16, in addition to the border or edge network elements explicitly shown in FIG. 1, may also include intermediate network elements which route communication traffic through the communication networks 12, 14, 16. Any or all of the communication networks 12, 14, 16 may thus include edge, core, and/or other types of communication equipment. In other embodiments, the techniques disclosed herein are used in conjunction with communication equipment which might not necessarily be connected in a network. References to communication equipment and connections should thus be interpreted accordingly.

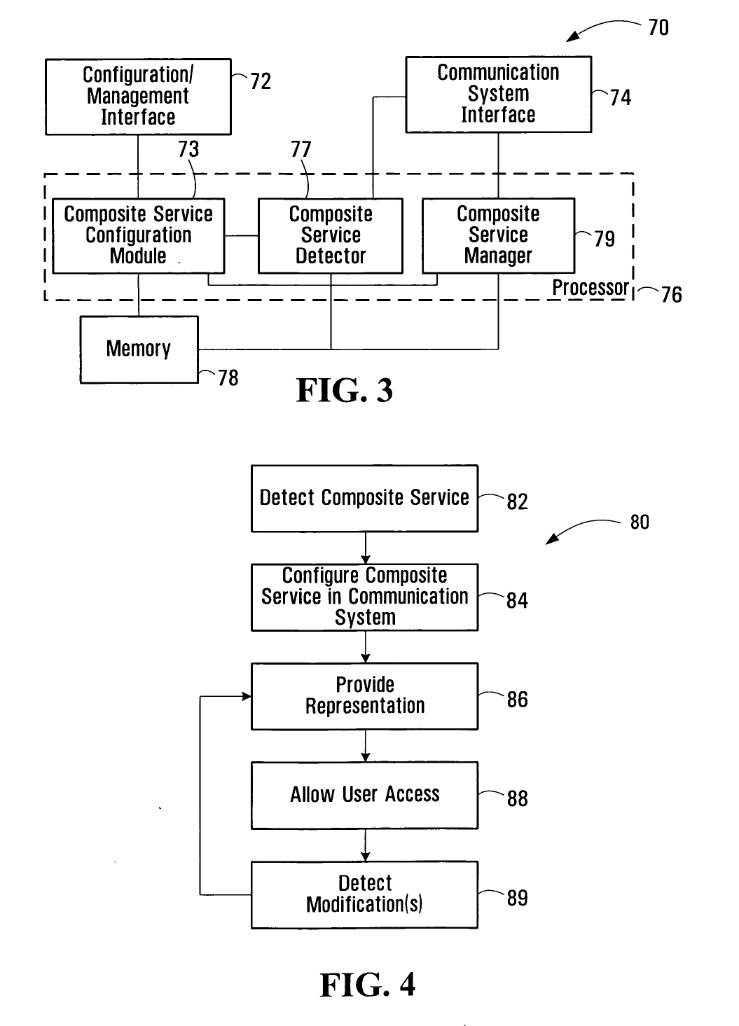

Functions for managing the communication networks 12, 14, 16, to configure connections and services, control communication equipment, and/or monitor network operations for instance, may be provided by the management system 36. Although shown as a single component in FIG. 1, multiple management systems may be implemented where communication equipment is operated by different entities. An example of a management system is described in detail below with reference to FIG. 3. Other management or control equipment, such as local operator terminals, may also be provided in any or all of the communication networks 12, 14, 16.

The multiple access devices 32, 34 distribute communication traffic to and/or receive communication traffic from end user equipment, such as computer systems, by which communication traffic is generated and transmitted and/or received and terminated. Where connections to end users are DSL (Digital Subscriber Line) connections, for example, the multiple access devices 32, 34 may be DSLAMs (DSL Access Multiplexers). Customer edge routers and other customer premises equipment are further examples of the multiple access devices 32, 34.

Many different types of network, access, and end user communication equipment, as well as the operation thereof, will be apparent to those skilled in the art. In general, communication traffic is transferred between sources and destinations, possibly through one or more of the communication networks 12, 14, 16. Traffic may be translated between different protocols or formats during its transfer. As discussed in further detail herein, the transfer of communication traffic may involve multiple communication services supported in the communication system 10, and illustratively communication services supported in the different communication networks 12, 14, 16, which have been configured to cooperate to provide a composite communication service.

In one particular example embodiment, traffic is routed in the communication network 12 using IP (Internet Protocol) or MPLS, the communication networks 14, 16 are Ethernet networks, and the multiple access devices 32, 34 are DSLAMs.

However, it should be appreciated that embodiments of the invention are not limited to any particular types of communication equipment, transfer mechanisms, or protocols. Those skilled in the art will be familiar with various communication system implementations and services in conjunction with which embodiments of the invention may be used. It is also contemplated that embodiments of the invention may be applicable to communication systems and services which are subsequently developed.

Communication services 11, 13, 15 are also shown in FIG. 1, in the form of service sites and interconnections therebetween. The communication services 11, 13, 15 are supported by communication equipment in the communication networks 12, 14, 16, in that these services transfer data through the communication equipment and physical connections between that equipment. However, the communication networks and their elements might not have any type of service “awareness”. For example, a network element would not normally know the complete topology of a communication service which has been set up by provisioning service sites at that network element. Moreover, communication equipment generally cannot distinguish a connection between service sites of the same communication service from a connection between service sites of different communication services. Clearly, communication equipment would normally be completely unaware when an SAP (Service Access Point) of one of its service sites, through which a communication service is accessible, is actually hooked up to an SAP of another service site for a different communication service via a cable, for example.

Consider an example scenario in which the whole system 10 under the management of the management system 36, illustratively an NSM (Network and Service Management system) through which both communication equipment and services can be configured and managed. The management system 36 can be used to provision service sites in any of its managed network elements, which includes all of the network elements 18, 20, 22, 24, 26, 28 in this example.

As shown in FIG. 1, the service sites 17, 19, 21, 23 are provisioned in the network elements 18, 20 and interconnected to set up a communication service 11 in the communication network 12, the service sites 25, 27, 31, 33, 35, 37, 39 are provisioned in the network elements 22, 24, 26 and interconnected to provide a communication service 13 in the communication network 14, and the service sites 43, 45, 47, 49 are provisioned in the network elements 28, 30 and interconnected to provide another communication service 15 in the communication network 16. Some of these service sites, specifically the service sites 17/25, 23/43, are connected between different services to establish a composite communication service which uses all of the individual communication services 11, 13, 15. Of course, other types of service site and communication service arrangements are also possible.

In the context of a composite communication service which encompasses all of the communication services 11, 13, 15, the network elements 18, 20, 22, 24, 26, 28 in the communication networks 12, 14, 16 may be considered a portion of an overall service provider network.

The relationship between actual equipment and communication services will be apparent to those skilled in the art from FIG. 1. Communication services effectively overlay the communication equipment. For example, connections between the network elements 18/22, 20/28 may be physical links, whereas logical connections between the service sites 17/25, 23/43, shown in dashed lines in FIG. 1, allow data transfer between service sites over the physical links.

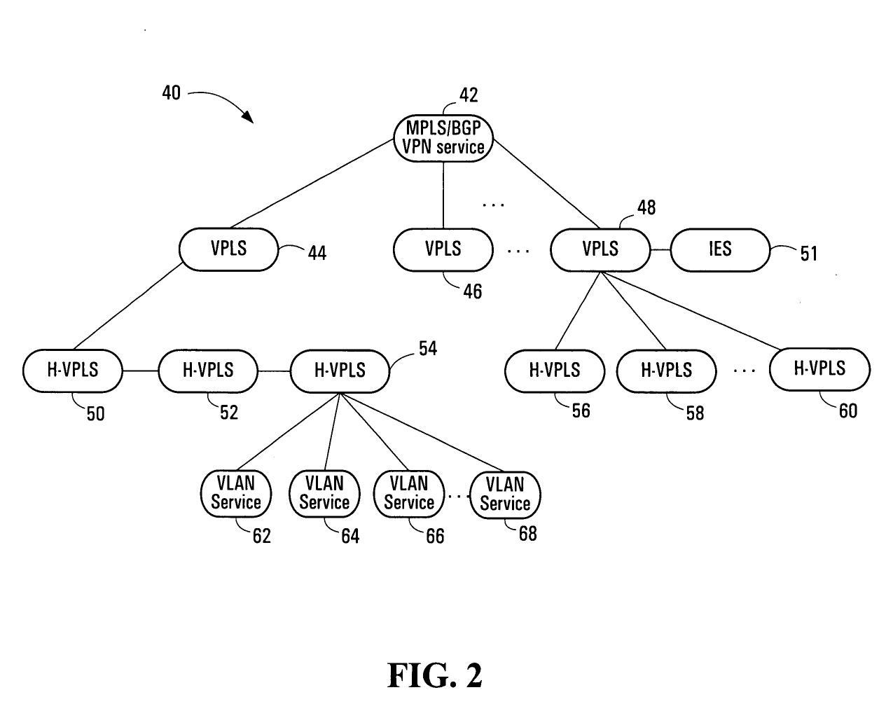

FIG. 2 is a block diagram illustrating component communication services involved in providing a composite communication service. In FIG. 2, a composite communication service 40 is provided by multiple component communication services of different technologies, including an MPLS/BGP VPN service 42, VPLSs 44, 46, 48, an IES (Internet Enhanced Service) 51, H-VPLSs (Hierarchical VPLSs) 50, 52, 54, 56, 58, 60, and VLAN services 62, 64, 66, 68. Other composite communication services may include fewer, further, or different component communication services than those shown.

A component communication service, also referred to herein as a communication service or component communication service, may be configured to provide a composite communication service. In some embodiments, a component communication service is configured to operate with other component communication service to provide a composite communication service. Illustrative examples of component communication services include the services shown in FIG. 2, with which those skilled in the art will be familiar.

The blocks shown in FIG. 2 provide a service-level view, as opposed to the combined equipment- and service-level view of FIG. 1, of a composite communication service. In terms of implementation, a VPLS, for example, might consist of one or more VPLS service sites operatively coupled to each other. A service site represents a service object in a network element, such as a VLL (Virtual Leased Line) service site or a VRF (Virtual Routing and Forwarding) service site of an MPLS/BGP VPN, or a VLAN object, for instance. A service may include multiple service sites. A VLL service site or a VPLS service site of a VPLS service can be operatively coupled or “connected” to one or more service sites of another VPLS service.

Those skilled in the art will be familiar with MPLS/BGP VPN, VPLS, H-VPLS, and VLAN services as shown in FIG. 2.

In one embodiment, the present invention provides a technique for configuring and connecting communication services of different types together to provide a composite communication service such as a business VPN. The related group of services, referred to herein as a composite communication service, is then managed as one single entity.

Considering a video/TV broadcast application for example, the MPLS/BGP VPN 42 may use PIM (Protocol Independent Multicast) and IGMP (Internet Group Management Protocol) to distribute TV channels to various metro Ethernets, shown in FIG. 2 as the VPLSs 44, 46, 48. Traffic is further broadcast to different areas of each city using H-VPLSs 50, 52, 54, 56, 58, 60, of which the H-VPLSs 50, 52, 54 are operatively coupled in a daisy chain. Low cost L2 switches or DSLAMs could be used at the last mile to implement the VLAN services 62, 64, 66, 68 in different ring groups or in different DSLAMs, for delivery of TV content to subscribers of the composite TV service.

The component communication services of the composite communication service 40 are operatively coupled to each other using service connectors, represented in FIG. 2 by solid lines adjoining some of the component communication services. Each service connector shown in FIG. 2 represents a logical link between two component communication services.

Different types of service connector may be employed to operatively couple the services together to provide the composite TV service. For example, interface to interface service connectors may be used between the VLAN services 62, 64, 66, 68 and the H-VPLS 54, and also between the MPLS/BGP VPN service 42 and the VPLSs 44, 46, 48. PW connectors may be used both to interconnect “satellite” H-VPLSs 50, 52, 54, and between the H-VPLSs 50, 56, 58, 60 and the VPLSs 44, 48. Another type of service connector, referred to herein as a cross-connect, may be used between services having service sites located in the same communication equipment, such as the VPLS 48 and the IES 51.

As will be apparent from the foregoing, a composite communication service is basically a set of communication services, supported in a communication system, some of which may have been configured to operate together. Service connectors are used in some embodiments to configure the communication services to operate together so as to provide the composite communication service.

The composite communication service 40 represented in FIG. 2, for instance, involves MPLS/BGP VPN, VPLS, H-VPLS, and VLAN technologies and interconnections between those technologies. Management of these interconnections using conventional management systems is difficult in that network operators or other management personnel could not easily identify relationships between communication services. In accordance with embodiments of the invention, a management system provides a representation of a composite communication service in which relationships between a communication service, a composite communication service, and any other communication services configured as part of the composite communication service, are clearly indicated.

As noted above, although a composite communication service and its component communication service(s) are supported by equipment in a communication system, the concept of a composite communication service itself may be unknown to the communication system, outside of a management system used to manage equipment and services of the communication system. Thus, the ability to manage composite communication services need not be disrupted by changes in the communication system. For instance, rules may be established for composite communication service creation, deletion, modification, and/or presentation. These rules can be enforced at the management system to prevent improper service connections from being added or to alert service management personnel to changes that have been made to the communication system in the field and affect a composite communication service, for instance. In the latter case, management personnel may then take appropriate action, to modify component communication services and/or connectors of the affected communication service. An improper connector may reflect incorrect configuration of component communication services, for example, which can be remedied by changing how the component communication services have been configured to operate with each other.

Despite the challenges of managing composite communication services, it may in many instances be desirable to configure multiple communication services, within or beyond the scope of a managed communication network or portion of a communication system, to provide a composite communication service. The component communication services may be of similar or different types.

Multiple VLAN services on different bridged networks, for example, could be connected to an H-VPLS. The VLAN service and the H-VPLS can be configured for operation with each other by creating an SCP (Service Connection Point) to SCP service connector using a management system. An SCP to SCP service connector is one type of service connector according to an embodiment of the invention, which may be used to configure component communication services to provide a composite communication service. SCP to SCP service connectors may also be used to configure other types of communication service than VLAN and H-VPLS, such as to connect VPLSs to a MPLS/BGP VPN service as shown in FIG. 2, or vice versa.

An SCP to SCP connector specifies a logical link between two SCPs. An SCP is a service interface through which a communication service is accessible at a service provider “side” of a service, as opposed to a user or subscriber side of the service which is accessible through an SAP. In relation to the physical communication system, the SCP to SCP logical link could run over a cable such as an Ethernet cable or over a network using FR (Frame Relay) or ATM (Asynchronous Transfer Mode), for instance.

As another example, it may be desired to provide a private data service with high speed Internet access. Such a private data service could be provided by bridging multiple L2 service sites, which provide L2 data services, via a VPLS instance. This could be achieved by SCP to SCP connectors described above, or through other types of service connector, including PW spoke connectors or, where the services which are to provide the composite private data service are supported on the same communication equipment, configurable cross-connectors.

PW spoke connections in a communication system may be used to create H-VPLS services, or to connect an IES and a VPLS. In one embodiment, a PW spoke is established by logically binding a communication service to a communication path. Where traffic in a binding is unidirectional, from the service to a communication tunnel for instance, a binding may be created at each endpoint service site to support bidirectional communications between services.

In some cases, multiple communication services may be may be supported on the same piece of equipment. For example, a single service router may incorporate multiple SAPs. Physical connections between such services could be made through a local cable connection or a configurable connection device, for instance. Whereas a cable would generally be installed between communication equipment ports or interfaces after deployment of communication equipment, when inter-SAP connections are to be established, a configurable connection device could be pre-installed on an equipment backplane, for example, and subsequently configured, from a management system at a remote location for instance, to connect equipment ports/interfaces.

It is expected that physical connections between communication equipment in the communication system, through which logical connections between communication services are established, will be either installed or already in place before communication services are configured to operate together to provide a composite communication service. If necessary, new physical connections may be installed to support inter-operation between services. Once any required physical connections have been installed or configured, as in the case of a configurable connection device for instance, composite communication service configuration may proceed.

Configuration of communication services and configuration of service connectors may be performed separately or effectively as part of the same process. A management system, for example, may provide multiple interfaces for managing communication services. The same communication equipment and services may be controlled through a CLI (Command Line Interface), an OSSI (Operation Support System Interface), and also through a GUI (Graphical User Interface) for instance. A composite communication service could be set up by entering a name for the composite communication service, specifying component communication services related to the composite communication service, and configuring service connectors to create logical associations or relationships between the component communication services. Actual configuration of the communication system to implement the logical associations specified in the service connectors may then be performed either manually, such as through the CLI, OSSI, or GUI, or automatically by the management system. The latter approach may generally be preferred, in that the entire composite communication service is then manageable as a single entity. Separate tasks for configuring each of the component communication services are then avoided.

Regardless of the configuration method, manual or automatic, a composite service may thereafter be managed as a single entity.

In one embodiment, the actual configuration of a composite communication service in the communication system involves causing equipment at the endpoints of a communication tunnel to exchange control signalling to set up unidirectional service to tunnel bindings in opposite directions so as to enable bidirectional communication between services through the tunnel.

Accordingly, although the communication system itself might not be “aware” of the concept of a composite communication service, management of a composite communication service through its component communication services and/or service connectors may have an effect on configuration of equipment and services in the network.

In a similar manner, communication system configurations which affect a composite communication service may be automatically detected and reflected at a management system. Configuration of two communication services to operate together may be detected and reflected in a composite communication service management GUI, for example. This aspect of the present invention is described in further detail below.

These and other functions which may be provided in embodiments of the invention will be appreciated from the following description of FIG. 3, which is a block diagram of a composite communication service management system.

FIG. 3 shows an illustrative example management system 70, which includes a configuration/management interface 72, a composite service configuration module 73 operatively coupled to the configuration/management interface 72, a composite service detector 77 operatively coupled to the composite service configuration module 73, a composite service manager 79 operatively coupled to the composite service configuration module 73, a communication system interface 74 operatively coupled to the composite service detector 77 and to the composite service manager 79, and a memory 78 operatively coupled to the composite service configuration module 73, to the composite service detector 77, and to the composite service manager 79. As shown, the composite service configuration module 73, detector 77, and manager 79 may be implemented using a processor 76, although the invention is in no way limited to this particular type of implementation.

A composite communication service management system may be implemented as part of an overall management solution for a communication system, and may thus operate in conjunction with other components and functions not explicitly shown in FIG. 3. Accordingly, embodiments of the invention may include further, fewer, and/or different components which are operatively coupled in a similar or different manner than shown. In addition, the particular division of functions shown in FIG. 3 is also intended only for illustrative purposes. The functions of the configuration module 73, the detector 77, and the manager 79 may be provided in more than three components or modules, or in a single component or module, in other embodiments.

The types of the interconnections between components of FIG. 3 will be, at least to some extent, implementation-dependent. Where the components of the system 70 are implemented in hardware, the interconnections may be provided through physical connectors such as a computer system bus. In some embodiments, at least the composite service configuration module 73, the composite service detector 77, and the composite service manager 79 are implemented in software for execution by the processor 76. In this case, the operative coupling between these components may instead be logical. For example, the composite service configuration module 73, the composite service detector 77, and the composite service manager 79 may access the same data structures in the memory 78, whereby the data structures represent a logical operative connection between the module 73, the detector 77, and the manager 79.

The configuration/management interface 72 may include one or more devices for receiving inputs from and/or providing outputs to a user. For example, a user may perform composite communication service management functions by entering or selecting information using a keyboard and mouse, and management of composite communication services may be simplified by information presented to the user on a display. The configuration/management interface 152 may support any or all of an OSSI for receiving commands such as composite communication service creation commands and/or other inputs from another system, and a GUI, for instance. Support for an OSSI may be provided using an interface such as an Application Programming Interface, for example, to allow external systems to interact with the management system 150.

In perhaps most implementations of embodiments of the invention, the management system 70 will communicate with the communication system in which a composite communication service is to be provided. The communication system interface 74 includes a transmitter, a receiver, or both, in the form of a transceiver for instance, to enable such communications.

As noted above, the management system 70 may send control signals to communication equipment in the communication system to configure the equipment and/or communication services which are supported by the equipment so as to provide a composite communication service. Another function which may be provided by embodiments of the invention is automatic discovery of composite communication services based on configurations of communication equipment in a communication system. To this end, configuration information associated with equipment and/or services in the communication system may be received by the management system 70 through the communication system interface 74, during a synchronization operation through which communication system configurations are reconciled with central system management records, for example.

Those skilled in the art will appreciate that the specific structure and operation of the communication system interface 74 is dependent upon the particular communication system and equipment with which the management system 70 is to communicate, the media and protocols used between the management system 70 and the communication system, and whether the management system 70 is to transmit, receive, or both transmit information to and receive information from the communication system.

The composite service configuration module 73, the composite service detector 77, and the composite service manager 79 may each be implemented in hardware, in software for execution by a processor 76, such as a microprocessor, an ASIC (Application Specific Integrated Circuit), an FPGA (Field Programmable Gate Array), or other type of processing element, or in some combination of hardware and software. Although a single processor 76 is shown in FIG. 3, multi-processor implementations are also contemplated, in which any or all of the module 73, the detector 77, and the manager 79 are implemented using more than one processing element. The other components of the management system 70 may similarly be implemented partially or entirely using hardware or software.

The memory 78 may include one or more memory devices of the same or different types. Solid state memory devices and devices for use with movable and/or removable storage media are illustrative of types of memory device which the memory 78 may include. It should also be appreciated that the memory 78 may be local to the management system 70 as shown, or a remote store at a server, for example, which is accessible by a management system. In one embodiment, the memory 78 is used to implement a database system.

In operation, the composite service detector 77 detects that a composite communication service, to be provided by one or more communication services supported in a communication system, has been defined. This composite service detection by the detector 77 may be based on user inputs entered into the composite communication system configuration module 73 through the configuration/management interface 72, information received through the communication system interface 74, or both.

As noted briefly above, a user may invoke a function to define a new composite communication service and enter information such as a name and possibly other information associated with the new composite communication service. In one embodiment, this function is invoked by clicking on a button or menu item in a UI presented to a user in the configuration/management interface 72. These inputs are received by the configuration module 73, and the detector 77 then detects that a composite communication service has been defined based on the user inputs.

Component communication services may similarly be configured by a user when the composite communication service is created or at a later time. In this case, configuration of a communication service to provide the composite communication service can also be detected by the detector 77 based on the user inputs. Service connectors, such as the types noted above, may also be added by a user and detected by the detector 77 where multiple communication services are involved in providing a composite communication service.

It is also possible that a user may remove service connectors and/or component communication services from a composite communication service.

Thus, a composite communication service might include zero or more component communication services. Some or all of the component communication services may be configured to cooperate to provide the composite communication service by adding service connectors.

The composite communication service manager 79 provides a representation of the composite communication service. The representation may be in the form of a visual representation displayed to a user through the configuration/management interface 72. A representation may also or instead be provided by storing data records in the memory 78.

Management of a composite communication service is simplified by including in the representation an indication of whether a component communication service has been configured to provide the composite communication service. A visual representation, for example, may include a representation of a composite communication service such as the name of the composite communication service, and a representation of any or all component communication services of the composite communication service, illustratively as respective icons. In this case, when a user chooses to view details of a composite communication service, it can easily be determined whether any component communication services have been configured to provide the composite communication service. If a component communication service icon is displayed, then a user knows that the component communication service has some sort of relationship with the composite communication service.

In a stored representation, data stored in the memory 78 explicitly indicates relationships between a composite communication service and its component communication services.

The composite service manager 79 may provide subsequent access to the representation so as to allow a user to perform management functions for the composite communication service through the configuration module 73. Management functions may include configuring a communication service supported by the communication system to provide the composite communication service, removing a communication service from the composite communication service, deleting the composite communication service, and/or other functions through which a composite communication service may be modified. Modification of a composite communication service may also be detected by the detector 77 and reflected in the representation provided by the manager 79.

The composite service manager 79 may also determine whether component communication services have been properly configured in the communication system. Control signals may then be sent to the communication system through the communication system interface 74 to configure the component communication services. This may involve communicating with communication equipment to cause the equipment to establish bindings between services and a communication tunnel for instance.

Turning now to the feature of detection of a composite communication service based on configurations in the communication system, configuration information associated with a communication service supported in the communication system may be received by the management system 70 through the communication interface 74, as noted above. The detector 77 receives this configuration information either directly from the interface 74 or through the memory 78. The configuration information might be received and stored to the memory 78 by the composite service manager 79 and then accessed and analyzed by the composite service detector 77 to determine whether a communication service has been configured for operation with another communication service to provide a composite communication service.

In some embodiments, this function of the detector 77 is accomplished by discovering configurations which reflect management system service connectors. Connectivity among services provisioned in communication equipment, regardless of equipment type/version or service types, can thus be determined by the detector 77. Any affected composite communication services are then updated accordingly by the manager 79. New composite communication services can also be formed due to newly discovered relationships between services. The manager 79 may also enforce connection and connector rules and raise alarms and/or undertake other courses of action based on those rules.

The detector 77 may be adapted to detect any of the connector types described above, for example, and corresponding configurations of services in a communication system. SCP to SCP connectors specify a logical link between service interfaces, which in some embodiments may represent basically an SAP to SAP connector. For L2 switches, the an SCP to SCP connector could have one end from an uplink (a network interface) to a SAP. Based on L1/L2 (cable, LAG (Logical Aggregation Group), APS (Automated Protection Switch)) connectivity, and the channels (for SONET/SDH) and encapsulation types and values, for example, a connection between two SCPs can be formed to create or modify a composite communication service, and later detected by the detector 77. Two SAPs with QinQ encapsulation and the same outer/inner values on the ends of the physical links could be detected by the detector 77 as having been configured with a valid inter-service connection. A new SCP to SCP connector may then be automatically created at the management system 70.

Internal cross connections between communication services supported by the same piece of communication equipment, illustratively through a configurable connection device, can be discovered during scheduled resynchronization of the communication equipment or via network events (i.e., traps) from the communication equipment.

The discovery of PW spoke connections may involve matching of VC (Virtual Circuit) identifiers used at end service sites on different communication equipment. This process can also be performed at resynchronization time, or upon receiving network events from the communication equipment.

The detector 77 may also distinguish between different types of service site interconnections. For example, two connected service sites may be associated with the same or different communication services. From a service-level point of view, service connectors which represent connections between different communication services may be of most interest. Accordingly, the detector 77 could be configured to detect multiple types of connection, but to add service connectors representing only those detected connections which connect service sites of different services to a composite communication service.

It is important to note that the detector 77 may detect composite communication services by discovering actual configurations in the communication system, as reflected in configuration information received from the communication system, or by discovering service connectors established at the management system 70. In the former situation, service connectors corresponding to discovered configurations can be automatically added at the management system 70. This may be useful for the purposes of backward compatibility, where a composite communication service management system 70 is deployed in conjunction with a communication system which had formerly been managed using a conventional management system.

The latter example noted above involves discovery of service connectors which already exist at the management system. This situation might arise where a new connection between service sites of two services is created. Service provider personnel configuring a new connection via a CLI or OSSI, for example, might forget to later create a service connector representing the new connection in a composite communication service. Only the management system may be aware of the concept of a service connector. In this example, the communication system does not know whether the two newly connected service sites are of the same communication service or different communication services. The management system detects the new connection and determines if a service connector should be created.

Thus, configuration information used by the detector 77 to detect that a composite communication service has been defined may be received from the communication system or from a user of the management system 70, directly or through the composite service configuration module 73 and/or the memory 78.

Discovered service connectors or connections between services may or may not belong to an existing, previously defined composite communication service. For example, communication services could be configured for operation with each other through a CLI or other means outside a composite communication service management function of the management system 70. Even though in this case the services and the new service connector might not have been explicitly associated with a composite communication service, the manager 79 may automatically create a new composite communication service including the new service connector and the communication services it connects. A name and possibly other information associated with the new composite communication service may be automatically assigned by the manager 79 according to predefined policies, rules, or defaults for instance. Composite communication service information, and possibly information associated with the communication services and the service connector, may be stored to the memory 78 and/or presented to a user on a display. The manager 79 may also alert a user when a new composite communication service is automatically created.

As another example, a user might create a new service connector between one communication service which belongs to a composite communication service and another communication service which does not belong to the composite communication service. The new service connector may be discovered by the detector 77 and then added to the representation of the composite communication service by the manager 79. The manager 79 determines that the service connector connects a communication service of the existing composite communication service to another communication service, and thus that the service connector should also be part of the composite communication service. Similarly, since the other communication service is connected to a component communication service of the composite communication service, the manager 79 may determine that the composite communication service should be updated to include the other service.

It is possible that discovered service connectors or connections are associated with communication services which have already been configured to provide different composite communication services. The manager 79, upon detecting this occurrence, may take any of several actions.

One possible action would be to raise an alarm for one or more of the communication services, the respective different composite communication services, and a service connector specifying a logical association between the communication services, if a service connector exists. A new service connector might not have been added by the manager 79 in this case, and thus a service connector might not yet exist.

The manager 79 may also or instead select one of the previously defined composite communication services and update both composite communication services so that only the selected composite communication service includes the component communication services and a service connector between the services. Any other affected services may also be moved to the selected composite communication service. Affected services include services that are currently connected to either of the component communication services through other service connectors or connections.

Various criteria may be used by the manager 79 to decide to which composite communication service the component communication services and service connector should be added. One possible rule which could be applied by the manager 79 is to include the component communication services in the older composite communication service. The component communication services might instead be included in the composite communication service based on a calculated weight of each composite communication service. Composite communication service weights could be determined on the basis of one or more of: a total number of component communication services in each composite communication service, a number of service connectors in each composite communication service, and a number of subscribers to each composite communication service for instance.

Another possible selection or weighting criterion is based on a hierarchical arrangement of each composite communication service. Component communication services may be assigned to levels or tiers in a hierarchy of a composite communication service according to a type of each composite communication service or the OSI (Open Systems Interconnection) layer associated with the composite communication service, for example. A mapping between services and tiers may be specified in a lookup table stored in memory, or by other means. With reference to FIG. 2, the MPLS/BGP VPN service 42 is at a top tier of the composite communication service, the VPLSs 44, 46, 48 and the IES 51 are at the next tier, the H-VPLSs 50, 52, 54, 56, 58, 60 are at the next lower tier, and the VLAN services 62, 64, 66, 68 are at a lowest tier of the composite communication service 40. Possible tier-based decision criteria include selecting the composite communication service having the most or least tiers, or selecting the composite communication service in which a component communication service associated with a discovered connection or service connector has been assigned to a higher or lower tier.

Explicit selection of one of the composite communication services by a user, responsive to an alarm or user prompt, is also contemplated.

Another option for handing the multiple composite communication service situation is to create a new composite communication service including the communication services and a service connection between those services. Any or all affected services may also be moved to the new composite communication service.

The manager 79 may also enforce additional rules to control how composite communication services are managed. For example, as will be apparent from the foregoing, the manager 79 may enforce a rule that a communication service may be configured to provide only one composite communication service. A set of composite communication service rules may also or instead include one or more of the following rules, among others: a rule that a communication service may be removed from a composite communication service only if the communication service is not configured for operation with any other communication service which provides the composite communication service, and a rule that a composite communication service may be deleted only if no communication services are configured to provide the composite communication service. Thus, service connectors and services may first have to be removed from a composite communication service before component communication services and/or composite communication services can be moved or deleted.

FIG. 4 is a flow diagram of a composite communication service management method. The method 80 begins at 82 with an operation of detecting that a composite communication service, to be provided by one or more communication services supported in a communication system, has been defined. As described above, this detection may be based on inputs received from a user and/or configuration information associated with a communication service supported in the communication system.

At 84, equipment and/or component communication services in the communication system may be configured by sending configuration commands into the communication system. This operation might not be performed in all embodiments or for every composite or component communication service, such as where the composite communication service detection at 82 was based on the detection of actual configurations of component communication services in the communication system.

The method 80 proceeds at 86 with an operation of providing a representation of the composite communication service. The representation includes an indication of whether a communication service is configured to provide the composite communication service, and may be provided in the form of information stored in a memory and/or a visual representation presented on a display.

Once a composite communication service has been defined, a user may be allowed to access the representation of the composite communication service, as shown at 88. Such user access enables a user to manage the composite communication service by changing its component communication services and/or its service connectors. These and possibly other modifications to the composite communication service, whether made by modifying the representation or by making changes in the communication system, are detected at 89, and the representation of the composite communication service is updated accordingly at 86.

Various ways of performing the operations shown in FIG. 4, as well as other operations which may be performed in some embodiments, may be apparent from the foregoing description of the management system 70 of FIG. 3.

Those skilled in the art will also appreciate that further variations of the method 80 are possible. Other embodiments of the invention may involve further, fewer, and/or different operations performed in a similar or different order than shown.

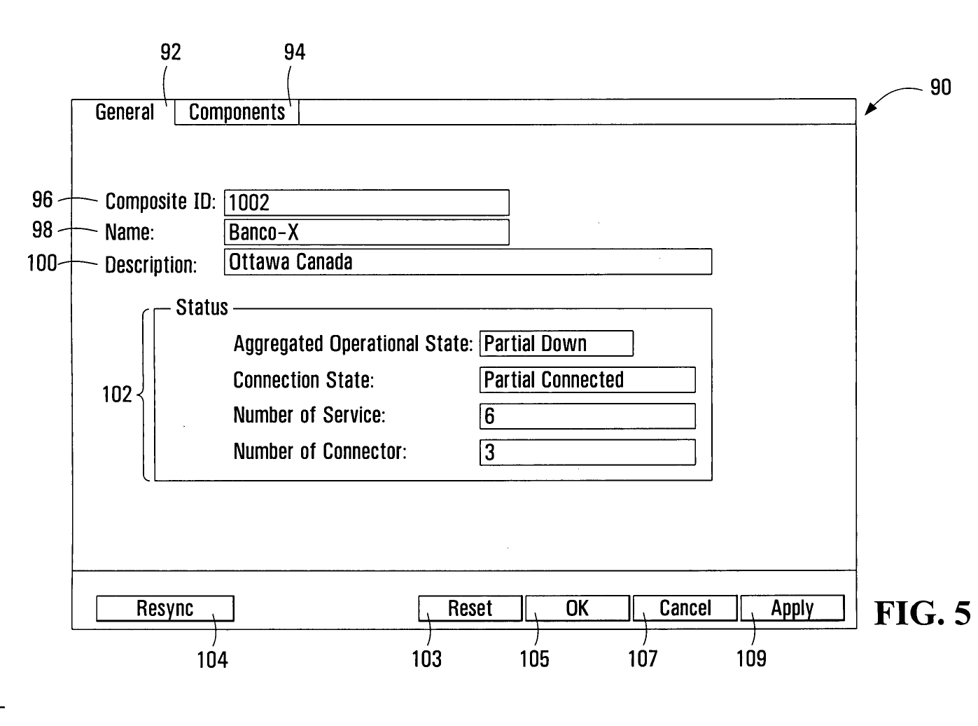

The process of defining and managing a composite communication service will be further described with reference to example UIs which may be provided in embodiments of the invention. The UIs shown in FIGS. 5-8 are intended solely for the purposes of illustration, and do not limit the scope of the invention. Other embodiments of the invention may implement composite communication service management functions using different UI layouts and elements, or even non-graphical UI techniques such as a CLI. In addition, the UIs shown in FIGS. 5-8 are associated with specific types of composite communication service, component communication service, and service connector. UIs for different types of service and service connector may be substantially similar or different than shown.

FIGS. 5-8 and the corresponding descriptions thereof should be interpreted accordingly.

FIG. 5 is a block diagram of a UI for defining and managing a composite communication service. The UI 90 includes tabs 92, 94 for moving between general information and component communication service information for a composite communication service. General composite communication service information is shown in FIG. 5, and component communication service information is described in further detail below.

As shown, general composite communication service information includes an identifier 96, which in some embodiments is automatically assigned when a user invokes a function to define a new composite communication service.

At 98 and 100, respectively, a composite communication service name and description may be entered for a new composite communication service or modified for an existing composite communication service.

Status information is presented in the UI 90 at 102. Although the status information at 102 reflects statuses which are automatically determined by a management system and presented in the UI 90, it should be appreciated that user control of composite communication service status is also contemplated. A user may wish to explicitly control the operational state of a composite communication service, when the composite communication service is first being created for instance.

The status information at 102 includes and aggregated operational state, which may be determined on the basis of operational states of any component communication services and/or service connectors, for example. Connection state provides an indication of whether all component communication services are “reachable” by all other component communication services through service connectors and connections in the communication system. This does not necessarily mean that every component communication service must be connected to each other component communication service by a service connector, or that every component communication service would actually communicate with all other component communication services. The composite communication service 40 shown in FIG. 2, for example, might be characterized as fully connected in that every component communication service is at least indirectly reachable by all other component communication services, even though not all of the services would necessarily communicate with all other services. The VPLSs 44, 48, for example, might never communicate with each other, but could still be considered reachable and connected for the purposes of determining connection state of the composite communication service 40.

Indications of the number of services and the number of connectors in the composite communication service are also provided at 102.

Various functional visual elements which allow a user to invoke respective functions are shown at 104, 103, 105, 107, 109. The resync element 104 invokes a resync function to update a management system database and/or configurations in a communication system to reflect any modifications made to a composite communication service. Selection of the reset element 103, using a mouse and cursor for instance, resets at least user entered information in the UI 90. An “OK” function invoked by selecting the element 105 accepts user inputs and may close the UI 90, whereas an apply function invoked by selecting the element 109 may accept user inputs without closing the UI 90. Although selection of the resync element 104 invokes a resync operation immediately, composite communication service information distribution and/or configuration changes are performed on the next resync operation when the “OK” or apply elements 105, 109 are selected. The next resync operation could be manually invoked at a later time or performed in accordance with a predefined schedule or trigger conditions. A cancel function invoked by selecting the element 107 ignores any information entered by a user and may also close the UI 90.

Further, fewer, and/or different types of information and functions than shown in FIG. 5 may be provided in other embodiments.

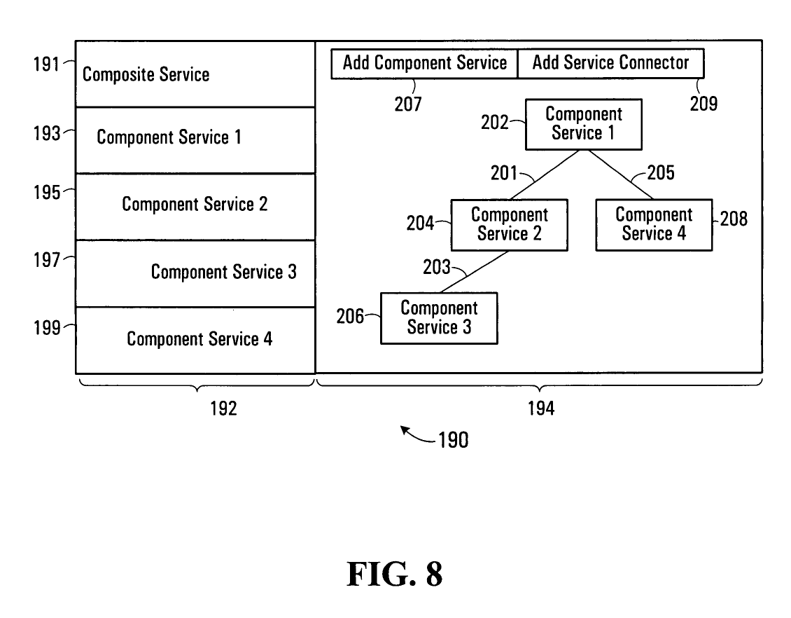

Selection of the components tab 94 at the top of the UI 90 allows a user to navigate to a listing or other representation of any component communication services which have been configured to provide the composite communication service. This representation, an illustrative example of which is shown in FIG. 8 and described in detail below, may also allow a user to manage component communication services and/or service connectors to a composite communication service. In another embodiment, component communication service and service connector management functions may be directly invoked from the UI 90.

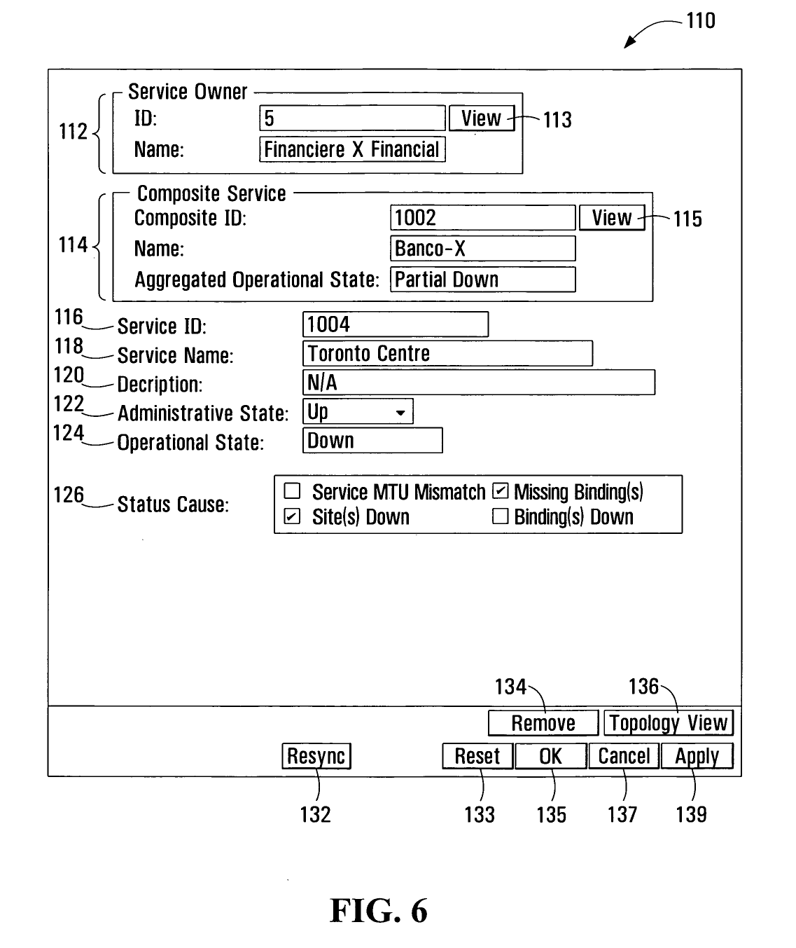

FIG. 6 is a block diagram of a component communication service UI which could be displayed when a user wishes to add a component communication service to a composite communication service or to view details of a component communication service which is already part of a composite communication service.

The UI 110 includes, at 112, information associated with an owner of the component communication service. An owner of a communication service may be a company, for example, which provides the communication service to end users who are subscribers of the service. A service owner may or may not also own the infrastructure through which the service is provided.

Other information associated with the owner is accessible to a user by selecting the view element 113, which may open another screen displaying subscriber information.

Information associated with the composite communication service to which the component communication service belongs or is being added is indicated at 114. The composite communication service information includes composite communication service ID, name, and aggregated operational state. The view element 115 provides access to other information for the composite communication service, and selection of the view element 115 may display the information, and possibly the UI 90, shown in FIG. 5.

Service-specific information presented in the UI 110 includes a service ID 116, which may be automatically assigned by a management system. A service name and description at 118, 120 may be entered by a user. Administrative status of the service at 122 is selectable from a pulldown menu in the example UI 110. Service operational state and some possible causes of operational states other than an “up” or analogous state are shown at 124, 126, respectively.

A component communication service might be an existing service which has already been created in the communication system, or a new service which is to be created and added to a composite communication service, for example. Creation of a new service may be accomplished by entering information in the UI 110 and possibly other information associated with the component communication service. The other service information may be accessible through a service information view element or tabs similar to those shown at 92, 94 in FIG. 5 for instance.

Removal of a component communication service from a composite communication service may be accomplished by selecting the remove element 134. If removal conditions are violated, where a service connector between the component communication service and another component communication service of the composite communication service exists, for example, an error message or other alert may be presented. The alert may allow the user to abort the removal operation or to proceed with removal of any or all of the component communication service, the service connector, and possibly any other affected component communication services. A move function, to move a component communication service from one composite communication service to another existing or new composite communication service, may be provided in a similar manner.

An analogous remove element and function may also be provided in the UI 90 to allow a user to remove a composite communication service. In the case of a composite communication service removal, an alert might be presented if all component communication services and/or service connectors have not already been removed from the composite communication service.

The topology view element 136 provides a user with access to a complete view of the composite communication service to which a component communication service belongs. FIG. 8 shows an example of a composite communication service topology view at 194, and is described in further detail below.

The resync, reset, “OK”, cancel, and apply elements 132, 133, 135, 137, 139 invoke respective functions described above with reference to FIG. 5, but for a composite communication service.

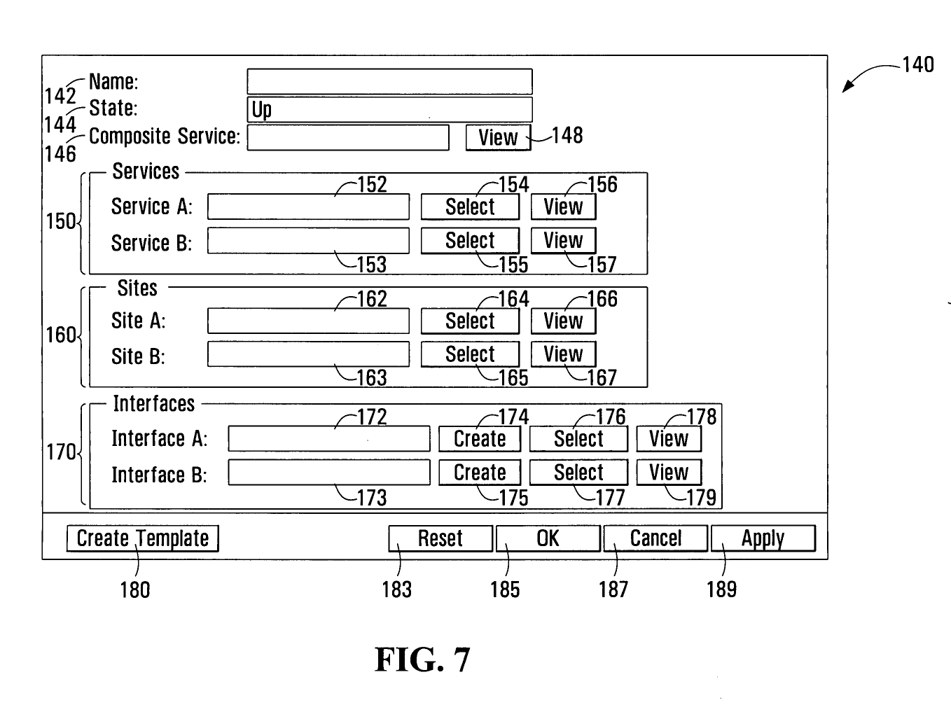

FIG. 7 is a block diagram of a service connector UI 140 which is presented when a user selects an add service connector, view service connector, or analogous function.

A service connector name may be entered and displayed at 142, and its state is displayed at 144. The composite communication service to which a service connector belongs or is to be added is displayed at 146. The composite communication service may be entered by the user or automatically populated by a management system. Pre-population of the composite communication service field at 146 might be preferred, for example, when an add or view service connector function is invoked from a composite communication service management UI as described below. Details of the composite communication service may be viewed by selecting the view element 148.

The component communication services connected or to be connected by the service connector are selected at 150. A user may select component communication service names or other identifiers from lists displayed when the elements 154, 155 are selected. A name or other identifier of each selected service is then displayed at 152, 153. Details of each service are accessible by selecting the elements 156, 157.

Service site and interface information for a service connector are configured and displayed in a substantially similar manner at 160, 170, by selecting from lists displayed when the elements 164/165, 176/177 are selected. Information is then displayed in the fields 162/163, 172/173. Details of service sites and interfaces are available through the view elements 166/167, 178/179.

A create new interface function, through which a user can specify and configure new interfaces, is invoked by selecting the elements 174, 175. Substantially similar elements may be provided in other embodiments to allow a user to also or instead configure new services and/or sites.

As noted above for component communication services, a service connector may be created from a template or used as a basis to create a new template. The create template function is shown in the UI 140 at 180.

The elements 183, 185, 187, 189 invoke functions which have been described above, for a service connector.

FIG. 8 is a block diagram of a UI displaying a representation of a composite communication service and component communication services configured to provide the composite communication service. The UI 190 includes a composite communication service listing portion 192 for displaying information associated with the composite communication service and a topology view portion 194 for displaying a representation of the composite communication service in terms of a topology of its component communication services and service connectors.

The portion 192 includes a visual element 191 representing the composite communication service. The element 191 may present the composite communication service name and/or other information defined for the composite communication service. The elements 193, 195, 197, 199 similarly present information for the component communication services of the composite communication service, which in the example shown includes four component communication services.

The display of information for both the composite communication service at 191 and its component communication services at 193, 195, 197, 199 is illustrative of one manner in which a UI may provide an indication that one or more component communication services have been configured to provide the component communication service. As described above, a composite communication service may have zero or more component communication services. If no component communication service information is displayed at 193, 195, 197, 199, then no component communication services have yet been added to the composite communication service.

The layout of the elements shown in the portion 192 may also provide an indication of relationships between component communication services. The order in which the composite communication services are listed at 192 and their indentation may reflect the hierarchical structure of the composite communication service, for example. In FIG. 8, the elements 193, 195, 197, 199 indicate that the component communication service 1 is at a highest tier of the composite communication service, the component communication services 2 and 4 are at the next tier, and the component communication service 3 is connected to the component communication service 2 and at a next lower tier.

Another way of representing a composite communication service is shown in the portion 194. An icon 202, 204, 206, 208 is displayed for each of the four component communication services. Service connectors between the icons are also displayed at 201, 203, 205, providing a complete picture of the composite communication service, its component communication services, and the connections therebetween.

Although not explicitly shown in FIG. 8, other information such as service and service connector type and status may also be indicated in the UI 190. In one embodiment, symbols are used to specify service and service connector types, whereas colors indicate states of any or all of component communication services, service connectors, and the composite communication service.

The UI 190 provides a clear representation of a composite communication service. This may significantly simplify management of composite communication services, particularly for composite communication services which involve inter-operation between multiple services of different types.

The elements 207, 209 are functional elements which may be selected by a user to invoke management functions, to add a component communication service and a service connector, respectively, to the composite communication service 207. Selection of the elements 207, 209 may result in the display of the UIs 110, 140 to allow a user to add a component communication service or service connector to the composite communication service.

The functional visual elements 207, 209, and similarly other functional visual elements disclosed herein, are intended solely for the purposes of illustration. UIs according to other embodiments of the invention may include additional elements for invoking other functions, for example. Other mechanisms for invoking management functions are also contemplated. Pulldown and/or popup menus may be used instead of or in addition to functional “button” visual elements. Further, component communication service- or connector-specific functions, to view, remove, move, and/or modify a service or connector for instance, may be invoked in some embodiments by clicking on or otherwise selecting a corresponding indicator 191, 193, 195, 197, 199 or icon 201, 202, 203, 204, 205, 206, 208 in the UI 190.

Although shown in a single UI 190, the portions 192, 194 are provided as different screens according to one embodiment of the invention. For example, the list representation at 192 could be presented to a user under the components tab 94 of the UI 90 of FIG. 5, whereas the representation at 194 may be presented when a user selects the topology view element 136 in the UI 110 of FIG. 6.

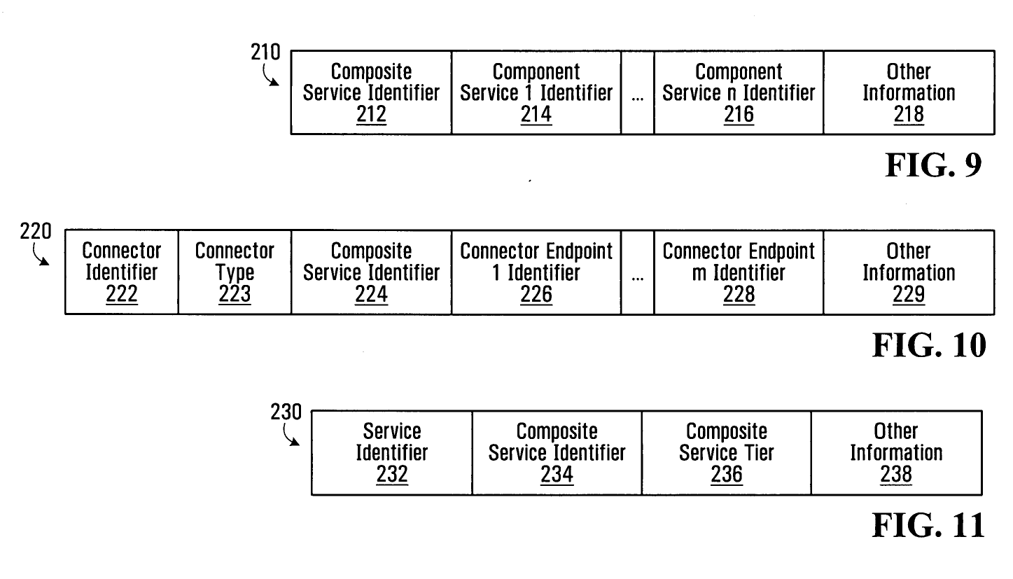

FIG. 9-11 are block diagrams of data structures in which information representing a composite communication service, a service connector, and a component communication service, respectively, may be stored. These data structures may be stored in the memory 78 of the system 70 (FIG. 3), for example, and updated as necessary to keep management system records accurate and current.

As noted above for the other drawings, FIGS. 9-11 present example data structures solely for the purposes of illustration, and do not limit the scope of the present invention. Other embodiments of the invention may include fewer, further, or different data fields arranged in a similar or different order than those shown.

The composite communication service data structure 210 includes information 212 such as a name and/or ID which identifies a composite communication service, information 214, 216 respectively identifying n component communication services of the composite communication service, such as a composite communication service name and/or ID, and other information 218 associated with the composite communication service, illustratively any or all of a description, aggregate operational state, number of composite communication services, and number of connectors.

The service connector data structure 220 includes information 222 such as name and/or ID identifying the service connector, information 223 indicating a type of the service connector, examples of which have been described above, information 224 such as name and/or ID identifying the composite communication service to which the service connector belongs, information 226, 228 such as name, ID, service site, and/or interface identifying the m endpoints connected by the service connector, and other service connector information 229, such as a state of the service connector. Although it is expected that service connectors will connect two communication services, one contemplated variation of the service connector concept is to define interconnections between more than two services.

The endpoint information provided at 226, 228 may include, for each communication service connected by the service connector, information identifying the communication service, a particular service site of the communication service, and connection information. A service connector which connects two services, services 1 and 2, for example, might include in the fields 226, 228 the data (Service ID 1, Service Site ID 1, SCP/bindingID/connection device ID 1) and (Service ID 2, Service Site ID 2, SCP/bindingID/connection device ID 2), respectively.

A component communication service is specified in the data structure 230 by a service identifier 232, which is information such as a name and/or ID identifying the communication service, a composite communication service identifier 234 which includes information identifying the composite communication service to which the service belongs, a composite communication service tier 236 indicating the tier or hierarchical level of the composite communication service to which the service has been assigned, and other information 238 such as service state.

Each data structure thus includes information identifying a composite communication service, at 212, 224, 234. The data structures also include information indicating whether a communication service supported in a communication system has a relationship with the composite communication service. In the data structures 210, 220 the information at 214/216 and 226/228 identify communication services which are related to the composite communication service. The service identifier 232 in the data structure 230 identifies a service which is related to the composite communication service identified at 234.

It should be appreciated that data records stored at a management system may include more than one of the data structures shown in FIGS. 9-11. A management system database may include one or more composite communication service data records embodying the data structure 210, one or more service connector data records embodying the data structure 220, and one or more communication service data records embodying the data structure 230.

It should also be noted that other embodiments of the invention may use variations of the example data structures 210, 220, 230. Where a service connector or service is allowed to belong to more than one composite communication service, for example, multiple composite communication services may be identified at 224, 234, for example. Further variations are also possible without departing from the invention.

What has been described is merely illustrative of the application of principles of embodiments of the invention. Other arrangements and methods can be implemented by those skilled in the art without departing from the scope of the present invention.

For example, in some embodiments, composite communication services can be handled substantially as component communication services, such as to move a composite communication service into another composite communication service.

In addition, service connectors have been described above a providing a single connection between component communication services. Redundant connectors are also contemplated, to link together two VPLSs via a pair of service connectors to provide redundancy support for multiple subscribers' H-VPLSs, for instance. In the composite communication service 40 of FIG. 2, for example, any or all of the H-VPLSs 50, 56, 58, 60 could be coupled to its corresponding VPLS 44, 48 via multiple connectors so as to provide redundancy protection for communications between the VPLSs and the H-VPLSs and thus the composite communication service 40.

Another type of service connector which has not specifically been described above is a service connector between one communication service which is within the management domain of a management system and another communication service which is outside the management domain. For this type of connector, one endpoint could be an SCP, and the other endpoint a string used to describe the other non-managed service.

Embodiments of the invention may provide further composite communication service-related features, including those described in the related patent applications referenced above.

It should also be appreciated that variations in the manner of implementing embodiments of the invention are contemplated. Although described primarily in the context of methods and systems, the techniques disclosed herein may also or instead be implemented as instructions stored on a machine-readable medium, for example.

We claim:

1. A system comprising:
a composite communication service detector adapted to detect that a composite communication service, to be provided by one or more communication services supported in a communication system, has been defined; and
a composite communication service manager operatively coupled to the detector and adapted to provide a representation of the composite communication service, the representation comprising an indication of whether a communication service is configured to provide the composite communication service.

2. The system of claim 1, further comprising:
an interface adapted to receive inputs; and
a composite communication service configuration module operatively coupled to the interface and adapted to receive through the interface inputs for defining a composite communication service.

3. The system of claim 2, wherein the composite communication service configuration module is further adapted to receive through the interface inputs for configuring a communication service to provide the composite communication service.

4. The system of claim 2, wherein the interface is further adapted to allow access to the representation for performing management functions on the composite communication service, the management functions comprising one or more of: configuring a communication service supported by the communication system to provide the composite communication service, removing a communication service from the composite communication service, and deleting the composite communication service.

5. The system of claim 4, wherein the manager is further adapted to enforce a set of composite communication service rules, the set of rules comprising one or more of: a rule that a communication service may be configured to provide only one composite communication service, and a rule that a communication service may be removed from a composite communication service only if the communication service is not configured for operation with any other communication service which provides the composite communication service.

6. The system of claim 1, further comprising:
an interface operatively coupled to the detector and adapted to receive configuration information associated with a communication service supported in the communication system,
wherein the detector is adapted to detect that a composite communication service has been defined by determining, based on the configuration information, whether the communication service is configured for operation with another communication service supported in the communication system to provide a composite communication service.

7. The system of claim 1, further comprising at least one of:
a display, wherein the manager is adapted to provide a representation by displaying on the display a visual representation of the composite communication service; and
a memory, wherein the manager is adapted to provide a representation by storing in the memory a representation of the composite communication service.

8. The system of claim 1, wherein the detector is further adapted to determine whether a communication service supported in the communication system is configured to provide the composite communication service by detecting service connectors between communication services, each service connector specifying a logical association between communication services.

9. The system of claim 1, wherein the composite communication service comprises at least one service connector, each service connector specifying a logical association between communication services, the at least one service connector comprising one or more of:
a service connector specifying a logical association between service interfaces through which communication services are accessible;
a service connector specifying a pseudo-wire connection between communication equipment on which communication services are supported; and
a service connector specifying a connection, between services supported on common communication equipment, through a configurable connection device implemented in the communication equipment.

10. The system of claim 6, wherein the detector is adapted to determine whether the communication service is configured for operation with another communication service by determining whether the configuration information comprises a service connector specifying a logical association between the communication service and another communication service.

11. The system of claim 6, wherein the manager is adapted to determine whether the communication services are. configured to provide a previously defined composite communication service, to create a new composite communication service where the communication services are not configured to provide a previously defined composite communication service, and to update the previously defined composite communication service where the communication services are configured to provide the previously defined composite communication service.

12. The system of claim 11, wherein the manager is adapted to determine whether the communication services are configured to provide a previously defined composite communication service by determining whether one or more of the communication services are also configured to provide a previously defined composite communication service, and to update the previously defined composite communication service by updating the previously defined composite communication service to include the communication services where only one of the communication services is also configured to provide a previously defined composite communication service.

13. The system of claim 12, wherein the manager is adapted to perform one or more of the following operations, where more than one of the communication services are also configured to provide respective different previously defined composite communication services:
raise an alarm for one or more of the communication services, the respective different composite communication services, and a service connector specifying a logical association between the communication services;
select one of the respective different previously defined composite communication services and update the respective different previously defined communication services so that each of the communication services is included in only the selected previously defined composite communication service;
create a new composite communication service including the communication services; and
create a new composite communication service including the communication services and any other communication services with which one or more of the communication services have been configured for operation.

14. A method comprising:
detecting that a composite communication service, to be provided by one or more communication services supported in a communication system, has been defined; and
providing a representation of the composite communication service, the representation comprising an indication of whether a communication service is configured to provide the composite communication service.

15. The method of claim 14, wherein detecting comprises detecting that a composite communication function has been defined based on one or more of inputs received from a user and configuration information associated with a communication service supported in the communication system.

16. The method of claim 14, further comprising at least one of:
detecting that a composite communication service has been modified, wherein providing further comprises providing a representation of the modified composite communication service; and
detecting that a composite communication service has been deleted, wherein the representation of a deleted composite communication service is removed.

17. The method of claim 14, wherein providing comprises one or more of: displaying a visual representation of the composite communication service, and storing in a memory a representation of the composite communication service.

18. The method of claim 14, wherein communication services supported in the communication system are configured to provide a composite communication service using one or more service connectors, each service connector specifying a logical association between communication services.

19. The method of claim 14, wherein detecting comprises detecting that a communication service is configured for operation with another communication service supported in the communication system, the method further comprising:
determining whether the communication services are configured to provide a previously defined composite communication service;
creating a new composite communication service where the communication services are not configured to provide a previously defined composite communication service; and
updating the previously defined composite communication service where the communication services are configured to provide a previously defined composite communication service.

20. The method of claim 14, wherein detecting comprises detecting that a communication service is configured for operation with another communication service supported in the communication system, the method further comprising:
determining whether one or more of the communication services are also configured to provide a previously defined composite communication service;
updating the previously defined composite communication service to include the communication services where only one of the communication services is also configured to provide a previously defined composite communication service; and
where more than one of the communication services are also configured to provide respective different previously defined composite communication services, one or more of:
raising an alarm for one or more of the communication services, the respective different composite communication services, and a service connector specifying a logical association between the communication services;
selecting one of the respective different previously defined composite communication services and updating the respective different previously defined communication services so that each of the communication services is included in only the selected previously defined composite communication service;
creating a new composite communication service including the communication services; and
creating a new composite communication service including the communication services and any other communication services with which one or more of the communication services have been configured for operation.

21. A machine-readable medium storing instructions which when executed perform the method of claim 14.

22. A machine-readable medium storing a data structure, the data structure comprising:
information identifying a composite communication service to be provided by one or more communication services supported in a communication system; and
information indicating whether a communication service supported in the communication system has a relationship with the composite communication service.

23. The medium of claim 22, wherein the information indicating whether a communication service supported in the communication system has a relationship with the composite communication service comprises information identifying multiple communication services, the data structure further comprising:
information defining a logical connection between the communication services.

24. The medium of claim 22, wherein the composite communication service comprises a plurality of hierarchical levels, and wherein the information indicating whether a communication service supported in the communication system has a relationship with the composite communication service comprises information identifying a communication service, the data structure further comprising:
information indicating a hierarchical level of the communication service in the composite communication service.

25. The medium of claim 22, wherein the data structure comprises a plurality of data records, the data records comprising:
one or more composite communication service data records, each composite communication service data record comprising:
information identifying a composite communication service; and
information identifying one or more communication services supported in the communication system that are configured to provide the composite communication service, thereby indicating that the one or more communication services have a relationship with the composite communication service;
one or more service connector data records, each service connector data record comprising:
information identifying a composite communication service; and
information defining a logical connection between communication services supported in the communication system, thereby indicating that the communication services have a relationship with the composite communication service; and
one or more communication service data records, each communication service data record comprising:
information identifying a communication service supported in the communication system;
information identifying a composite communication service; and
information indicating a hierarchical level of the communication service in a plurality of hierarchical levels comprising the composite communication service, thereby indicating that the communication service has a relationship with the composite communication service.

26. A user interface comprising:
a visual element representing a composite communication service to be provided by one or more communication services supported in a communication system;
a visual element representing communication services configured to provide the composite communication service; and
respective visual elements representing a logical association, if any, between communication services configured to provide the composite communication service.
